(19) United States
(12) Patent Application Publication
(10) Pub. No.: US 2008/0275162 A1
(43) Pub. Date: Nov. 6, 2008

(54) Ptfe-Based Compositions

(75) Inventors: Thomas H. Schwab, Cumming, GA (US); Shari Weinberg, Atlanta, GA (US); Tiziana Poggio, Montechiaro d'Acqui (IT); Valeri Kapeliouchko, Alessandria (IT); Michele Laus, Alessandria (IT)

Correspondence Address: Solvay North America, LLC;c/o Kim Manson, Esq., 4500 McGinnis Ferry Road, Alpharetta, GA, 30005, US

(73) Assignee: SOLVAY (Societe Anonyme), Brussels (BE)

(21) Appl. No.: 12/094,871

(22) PCT Filed: Dec. 4, 2006
(86) PCT No.: PCT/EP06/69278

§ 371 Date: May 23, 2008

Related U.S. Application Data
(60) Provisional application No. 60/741,905, filed on Dec. 5, 2005.

(51) Int. Cl. C08L 79/08

(52) U.S. Cl. 523/201

(57) ABSTRACT

The invention relates to core-shell particles, said particles comprising:
a core consisting essentially of at least one tetrafluoroethylene (TFE) polymer [polymer (F)], said core having an average primary particle size of less than 100 nm
a shell consisting essentially of at least one high performance polymer [polymer (HPP)], wherein the polymer (HPP) is chosen among polycondensation polymers that have a heat deflection temperature (HDT) of above 80° C. under a load of 1.82 MPa when measured according to ASTM D648.

The core-shell particles of the invention advantageously allow obtaining molded articles with homogeneous properties, both when used alone and when used as additive, as they generally do not undergo segregation phenomena.

Still objects of the inventions are the process for manufacturing said core-shell particles, the use of said particles as additives, the composition and the articles thereof.

### CROSS-REFERENCE TO RELATED APPLICATIONS

The present application claims the benefit of U.S. application Ser. No. 60/741,905 filed Dec. 5, 2005, herein incorporated by reference.

### FIELD OF THE INVENTION

The present invention relates to a core-shell polymer particle comprising a core of a tetrafluoroethylene (TFE) polymer and a shell of a high performance polymer.

The present invention also relates to a method of manufacturing said core-shell particle.

Still an object of the invention is the use of said core-shell particle as ingredients/additives in polymer compositions.

The present invention also relates to a composition comprising said core-shell particles, which exhibit usually high transparency, excellent flame resistance, and lightweight and outstanding mechanical properties, particularly useful for aircraft interior applications

The present invention finally relates to shaped article thereof.

### BACKGROUND

High performance polymers are widely used for many high-demanding applications, and in particular in many components for aircraft interior applications, such as window covers, ceiling panels, sidewall panels and wall partitions, display cases, mirrors, sun visors, window shades, stowage bins, stowage doors, ceiling overhead storage lockers, serving trays, seat backs, cabin partitions, and ducts. Key material properties are transparency and/or low color, lightweight, resistance to scratching, strength and stiffness, chemical resistance and flammability requirements.

High performance polymers such as sulfone polymers, in particular polyphenylsulfones (PPSU) have gained increased interest as aircraft interior materials, as they provide for high strength and stiffness at high temperature, they exhibit outstanding toughness among other polymers of same temperature class, they possess very good chemical resistance (so that they generally withstand exposure to cleaning fluids in aircraft industry), can be easily processed in the melt either for making injection molded articles or for extrusion of films and sheets, have excellent transparency and ease of colorability; moreover sulfone polymers are inherently flame-resistant materials with low smoke emission.

United States Government standards for the flame resistance of construction materials used for aircraft interiors are set out in the 1986 amendments to Part 25-Airworthiness Standards—Transport Category Airplanes of Title 14, Code of Federal Regulations (see 51 Federal Register 26206, Jul. 21, 1986 and 51 Federal Register 28322, Aug. 7, 1986). The flammability standards are based on heat calorimetry tests developed at Ohio State University (hereinafter “OSU Tests”). Such OSU Tests are described in the above-cited amendments to 14 CFR Part 25 and are incorporated herein by reference. These tests measure the two minute total heat release (in kilowatts minute per square meter of surface area, KW·min/m²) as well as the maximum heat release rate (in kilowatts per square meter of surface area, KW/m²) over the first five minutes for the material being tested, when burned under a specified set of conditions. The 1986 standards required engineering thermoplastics to have both of these heat release measurements under 100. The new 1990 compliance standards will allow a maximum of 65 for each of the two heat release measurements. Hence, a need exists to develop new thermoplastic compositions that will be able to meet these flammability standards, and yet display at the same time such other desirable features as toughness, chemical, solvent and cleaner resistance, and ease of fabrication into finished components.

Aromatic sulfone polymers, in particular polyphenylsulfones, offer today the best performances of commercially available transparent materials. Nevertheless, heat release performances of sulfone polymers are still inferior to those of opaque plastic materials containing appropriate conventional flame retardants.

By addressing the critical challenges of weight reduction, transparency and safety, several approaches can be prosecuted for improving the heat release performances of sulfone polymers.

Flame retarding additives such as triphenyl phosphate or melamine cyanurate, which generally possess low flammability have been mixed with high performance polymers to reduce flammability of the thermoplastics. However, a blend of such a low flammability additive with a high performance polymer often does not yield a useable flame-resistant composition. For example, the low flammability additive may not be compatible, i.e. miscible with the high performance polymer, at additive concentrations necessary to achieve significant flame retardance, or the additive may not be stable at the processing and/or curing temperatures of the high performance polymer.

Furthermore, inorganic additives such as TiO₂, ZnO or Zinc borate offer reductions in heat release only at high loading levels (effect on flammability being merely a reduction due to dilution), but lightweight, processability and transparence advantages of high performance polymers are consequently lost. Minimization of specific gravity is very important in aircraft applications.

There is thus a need in the interior aircraft materials for transparent and/or translucent materials having reduced heat release during combustion, good processability and low specific density.

Fluorocarbon resins have been used in the past for the flammability improvement of high performance polymers, in particular of aromatic sulfone polymers.

U.S. Pat. No. 5,204,400 discloses flame retardant thermoplastic compositions comprising a poly(biphenyl ether sulfone) of general formula:

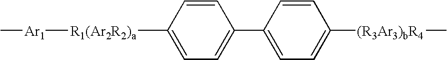

wherein R₁ through R₄ are —O—, —SO₂—, —S—, —C(O)—, with the provision that at least one of R₁ though R₄ is —SO₂— and at least one of R₁ though R₄ is —O—; Ar₁, Ar₂, Ar₃ are arylene radicals containing 6 to 24 carbon atoms,
together with anhydrous Zinc borate and a fluorocarbon polymer employed in the form of finely divided solids having a particle size of less than about 5 μm.

U.S. Pat. No. 5,916,958 discloses compositions comprising a poly(biphenyl ether sulfone) of formula:

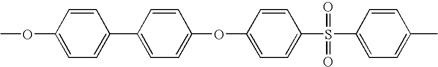

together with a fluorocarbon polymer, preferably a polytetrafluoroethylene (PTFE), and titanium dioxide, which exhibit enhanced flame retardant characteristics and which are useful for a wide variety of applications, such as to make aircraft interior parts.

U.S. Pat. No. 6,503,988 discloses flame resistive composition comprising a flammable thermoplastic resin, a flame retardant, and a polytetrafluoroethylene fine powder comprising particles of 0.05 to 1 μm as antidripping agent.

Nevertheless, dispersing PTFE materials in high performance polymers matrix is not easy; this can affect the efficiency in reducing the heat release; moreover, the resulting compositions, as described in the prior art, exhibit a pearlescent opaque appearance. These materials are thus difficult to color and cannot be used in application where transparency is required.

Core-shell structures have been proposed in the past for fluorinated materials for notably improving dispersibility.

EP patent application No 0735093 discloses core-shell composite fine particles having mean particles size of 0.05 to 1 μm, having a core of a fibrillating polytetrafluoroethylene and a shell of non-fibrillating polymer; the non-fibrillating polymer for forming the shell can be a low molecular weight PTFE, polyvinylidene fluoride (PVDF), fluorine-containing copolymer comprising at least one of tetrafluoroethylene, vinylidene fluoride and chlorotrifluoroethylene as component monomer, or at least one polymer selected from those prepared from a liquid hydrocarbon monomer (e.g. acrylic and methacrylic monomers).

EP patent application No 1243604 discloses compositions comprising core-shell particles having a core of polytetrafluoroethylene-based polymers (PTFE) and a shell of styrene-based polymers, wherein the particles contain an amount by weight of PTFE from 5 to 30% and wherein the PTFE core particles have an average diameter from 5 to 100 nm.

EP patent application No 1377617 discloses fluoropolymer particles comprising a core of high molecular weight PTFE and a shell of lower molecular weight PTFE or modified PTFE. The term “modified PTFE” refers to copolymers of TFE with such small concentrations of comonomer, such as for instance, hexafluoropropylene (HFP), perfluoro(methyl vinyl ether) (PMVE), perfluoro(propyl vinyl ether) (PPVE), perfluoro(ethyl vinyl ether) (PEVE), chlorotrifluoroethylene (CTFE), perfluorobutylethylene (PFBE), that the melting point of the resultant polymer is not substantially reduced below that of PTFE.

U.S. Pat. No. 5,506,281 discloses fluoropolymer colloidal particles comprising:
a) a core of an ethylene/tetrafluoroethylene copolymer, comprising from 32 to 60 mol % of units from TFE, from 40 to 60 mol % of units from ethylene and from 0 to 8 mol % of units from at least one copolymerizable fluoroolefinic monomer; and
b) a shell of a melt-processable polymer having a melting point of at least 20° C. lower than the copolymer of the core, said polymer being, for instance, polychlorotrifluoroethylene (PCTFE), PVDF, polyvinyl fluoride (PVF) or copolymers of ethylene with CTFE or TFE with at least one additional monomer.

U.S. Pat. No. 5,679,741 discloses tetrafluoroethylene polymerizate particles totally or partially encapsulated in a copolymer chosen from polyalkyl(meth)acrylates, poly(vinylacetate), styrene-acrylonitrile and styrene-acrylonitrile-alkyl(meth)acrylate copolymers.

All these core-shell materials are not suitable for be used in combination with high performance polymers.

There is thus a need in the interior aircraft materials for additives yielding transparent and/or translucent (that is to say transparent in only one direction) materials having reduced heat release during combustion, good processability and low specific density.

According to the present invention, the above-mentioned difficulties and others are remarkably overcome by the inventive core-shell particles, said particles comprising:
a core consisting essentially of at least one tetrafluoroethylene (TFE) polymer [polymer (F)], said core having an average primary particle size of less than 100 nm
a shell consisting essentially of at least one high performance polymer [polymer (HPP)].

The core-shell particles of the invention advantageously allow obtaining molded articles with homogeneous properties, both when used alone and when used as additive, as they generally do not undergo segregation phenomena.

When combined with high performance plastic compositions, the core-shell particles of the invention can be easily dispersed and advantageously provide for compositions displaying an unexpected combination of excellent mechanical properties, excellent chemical resistance, excellent optical properties (transparency and colorability) and low flammability. Moreover, compositions comprising the core-shell particles according to the invention are notably easy to melt-fabricate, providing molded articles having smooth and aesthetically pleasing surface characteristics. The invented materials are advantageously readily pigmented in a wide range of colors, and are useful in a number of applications, in particular for the construction of various panels and parts for aircraft interiors.

For the purpose of the invention, the term “polymer” is intended to denote any material consisting essentially of recurring units, and having a molecular weight above 3000.

For the purpose of the invention, the term “oligomer” is intended to denote any material consisting essentially of recurring units, and having a molecular weight below 3000.

For the purpose of the invention the term “particle” is intended to denote a mass of material that, from a geometrical point of view, has a definite three-dimensional volume and shape, characterized by three dimensions, wherein, generally, none of said dimensions exceed the remaining two other dimensions of more than 10 times. Particles are generally not equidimensional, i.e. are longer in one direction than in others.

The shell consisting essentially of polymer (HPP) advantageously takes the form of a material disposed on the core, preferably completely surrounding (e.g., encapsulating) the core. Still, it is possible for production processes to result in particles wherein the shell does not completely surround the core, but only partially covers the core, leaving a portion of the core exposed. These particles, if produced, will typically be present in relatively small amounts, typically less than 10% compared to core-shell particles where the shell does completely surround or encapsulate the core.

The term “at least one high performance polymer [polymers (HPP)]” is understood to mean that the shell may consist essentially of one or more than one polymer (HPP).

Similarly, the term “at least one TFE polymer [polymer (F)]” is understood to mean that the core may consist essentially of one or more than one polymer (F).

The core and/or the shell of the particles of the invention may further comprise other additives and other ingredients which are used in the manufacturing process. Said components are generally present in reduced amount, typically as traces, and do not interfere with the properties and chemical behavior of the particles of the invention.

High performance polymers (HPP) are defined as polycondensation polymers that have a heat deflection temperature (HDT) of above 80° C. under a load of 1.82 MPa when measured according to ASTM D648. Typical heat deflection temperatures of certain high performance plastics are listed in Table 1.

TABLE 1
High performance polymers

| | Heat Deflection |
|---|---|
| Polycondensation Polymer | Temperature (° C.) |
| Polysulfone | 174 |
| Polyethersulfone | 203 |
| Polyphenylsulfone | 204 |
| Polyphthalamide | 120 |
| Polyamideimide | 278 |
| Liquid crystalline polymers (LCP) | 180-310 |
| (there are several different conventional LCPs) | |
| Polyimide | 360 |
| Polyetherimide | 200 |
| Polyetheretherketone (low flow) | 160 |
| Polyetheretherketone (high flow) | 171 |
| Polyphenylene sulfide | 135 |
| Polycarbonate | 132 |

Heat deflection temperatures of polymers are typically determined according to ASTM D648, Method A, using a span of 4 inches. The polymer is generally injection molded into plaques that are 5 inches long, ½ inch wide, and ⅛ inch thick. The plaques are usually immersed in a suitable liquid heat-transfer medium, such as oil, during the HDT test. Dow Corning 710 silicone oil, for example, can be used.

High performance polymers [polymers (HPP)] useful herein include, but are not limited to, aromatic polyimides (PI), in particular polyamide-imides (PAI), aromatic sulfone polymers [polymer (P)], polyaryletherketones (PAEK), such as polyetheretherketone (PEEK), polyetherketoneketone (PEKK), and liquid crystal polymers (LCP).

Preferably the polymer (HPP) is thermoplastic.

The term “thermoplastic” is understood to mean, for the purposes of the present invention, polymers existing, at room temperature, below their glass transition temperature, if they are amorphous, or below their melting point if they are semi-crystalline, and which are linear (i.e. not reticulated). These polymers have the property of becoming soft when they are heated and of becoming rigid again when they are cooled, without there being an appreciable chemical change. Such a definition may be found, for example, in the encyclopedia called “Polymer Science Dictionary”, Mark S. M. Alger, London School of Polymer Technology, Polytechnic of North London, UK, published by Elsevier Applied Science, 1989.

Thermoplastic polymers are thus distinguishable from elastomers and thermosetting polymers.

To the purpose of the invention, the term “elastomer” is intended to designate a true elastomer or a polymer resin serving as a base constituent for obtaining a true elastomer.

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

To the purpose of the invention, the term “thermosetting polymer” is intended to denote a polymer which, once shaped into a permanent form, usually with heat and pressure, cannot be remelted or reshaped because the basic polymeric component has undergone an irreversible chemical change. The operation by which the raw material is converted to a hard, insoluble and infusible product is generally referred to as cure (or curing) and corresponds to the final step of the polymerization reaction. A thermosetting polymer may be cured by the use of heat, radiation, catalysts or a combination of these.

According to a first preferred embodiment of the invention, the high performance polymer is an aromatic polyimide (PI) chosen among aromatic polyesterimides and aromatic polyamide-imides (PAI). Most preferably the high performance polymer is a PAI.

According to a second preferred embodiment of the invention, the high performance polymer is an aromatic sulfone polymer [polymer (P)].

To the purpose of the present invention, “aromatic polyimide (PI)” is intended to denote any polymer comprising recurring units, more than 50 wt % of said recurring units comprising at least one aromatic ring and at least one imide group, as such (formula IA) or in its amic acid form (formula 1B) [recurring units (R1)]:

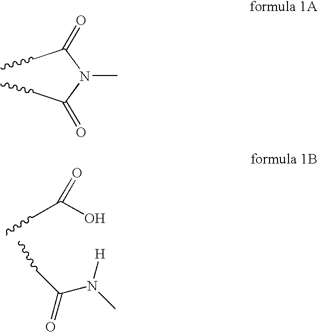

The imide group, as such or in its corresponding amic acid form, is advantageously linked to an aromatic ring, as illustrated below

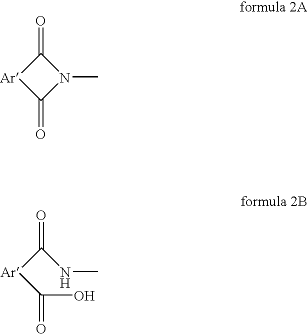

whereas Ar′ denotes a moiety containing at least one aromatic ring.

The imide group is advantageously present as condensed aromatic system, yielding a five- or six-membered heteroaromatic ring, such as, for instance, with benzene (phthalimide-type structure, formula 3) and naphthalene (naphthalimide-type structure, formula 4).

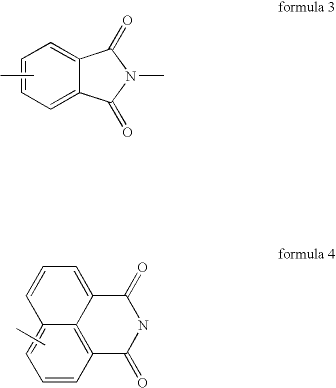

The formulae here below depict examples of recurring units (R1) (formulae 5A to 5C):

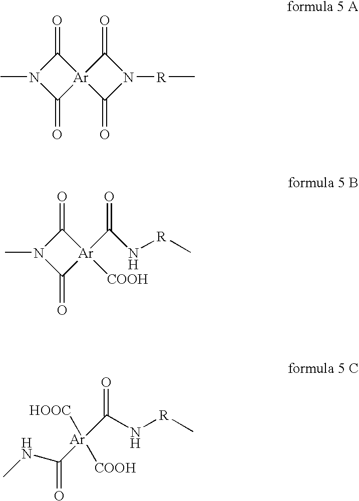

where:
Ar is typically:

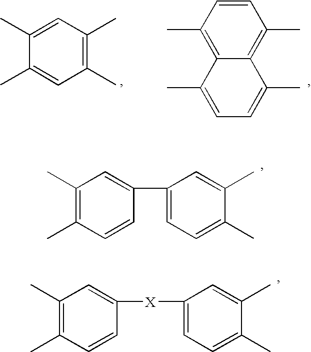

with X=

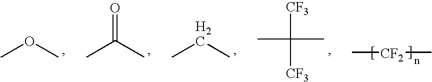

with n=0, 1, 2, 3, 4 or 5;
R is typically:

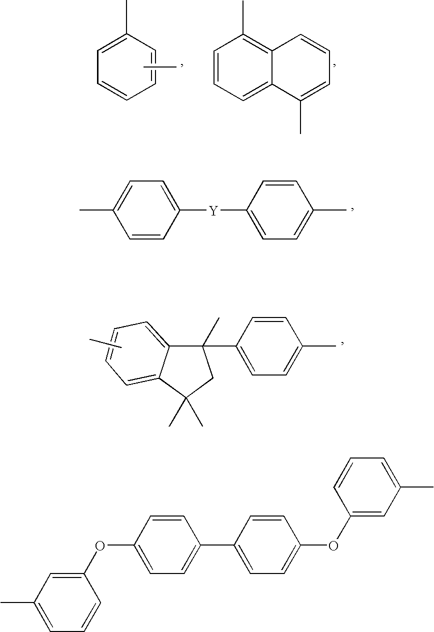

with Y=

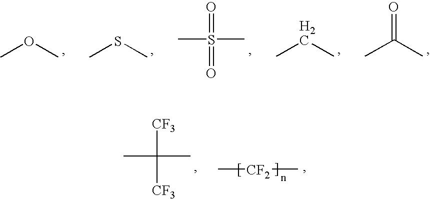

with n=0, 1, 2, 3, 4 or 5.

Polyimides commercialized by DuPont as VESPEL® polyimides or by Mitsui as AURUM® polyimides are suitable for the purpose of the invention.

The recurring units (R1) of the aromatic polyimide can comprise one or more functional groups other than the imide group, as such and/or in its amic acid form. Non limitative examples of polymers complying with this criterion are aromatic polyetherimides (PEI), aromatic polyesterimides and aromatic polyamide-imides (PAI).

The high performance plastic is more preferably an aromatic polyimide chosen from aromatic polyamide-imides (PAI) and aromatic polyesterimides. Still more preferably, the high performance plastic is an aromatic polyamide-imide (PAI).

To the purpose of the present invention, “aromatic polyesterimide” is intended to denote any polymer more than 50 wt % of the recurring units comprise at least one aromatic ring, at least one imide group, as such and/or in its amic acid form, and at least one ester group [recurring units (R2)]. Typically, aromatic polyesterimides are made by reacting at least one acid monomer chosen from trimellitic anhydride and trimellitic anhydride monoacid halides with at least one diol, followed by reaction with at lest one diamine.

To the purpose of the present invention, “aromatic polyamide-imide (PAI)” is intended to denote any polymer comprising more than 50 wt % of recurring units comprising at least one aromatic ring, at least one imide group, as such and/or in its amic acid form, and at least one amide group which is not included in the amic acid form of an imide group [recurring units (R3)].

The recurring units (R3) are advantageously chosen among:

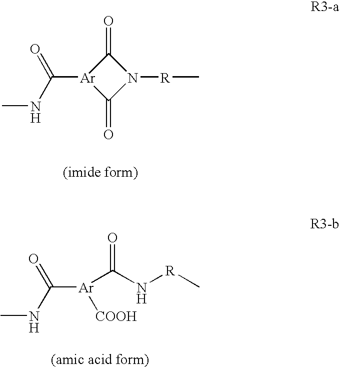

where:
Ar is typically

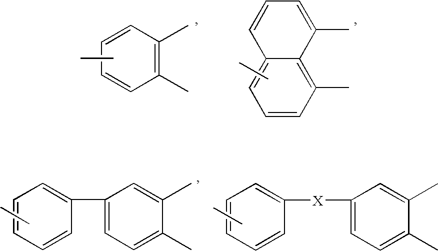

with X=

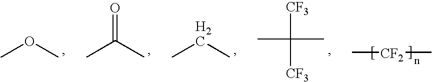

with n=0, 1, 2, 3, 4 or 5;
R is typically:

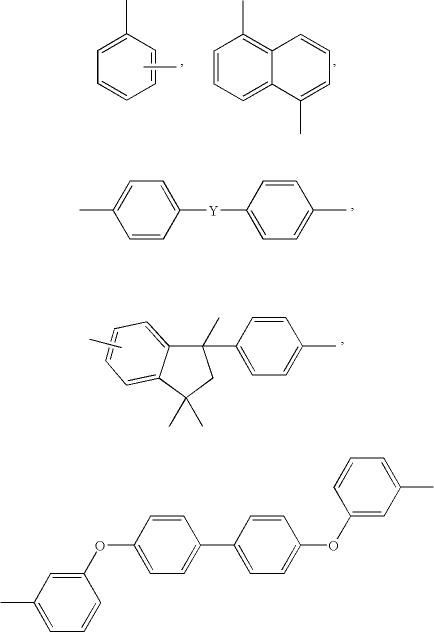

with Y=

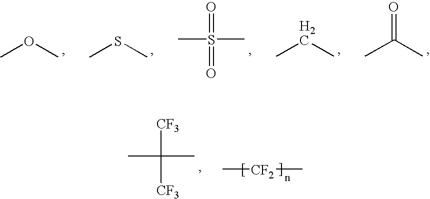

with n=0, 1, 2, 3, 4 or 5.

Preferably, the aromatic polyamide-imide comprises more than 50% of recurring units (R3) comprising an imide group in which the imide group is present as such, like in recurring units (R3-a), and/or in its amic acid form, like in recurring units (R3-b).

Recurring units (R3) are preferably chosen from recurring units (l), (m) and/or (n):

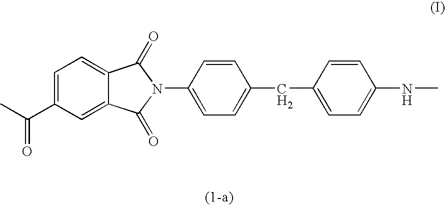

and/or the corresponding amide-amic acid containing recurring unit:

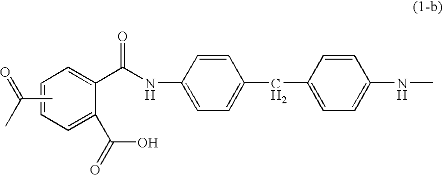

wherein the attachment of the two amide groups to the aromatic ring as shown in (1-b) will be understood to represent the 1,3 and the 1,4 polyamide-amic acid configurations;

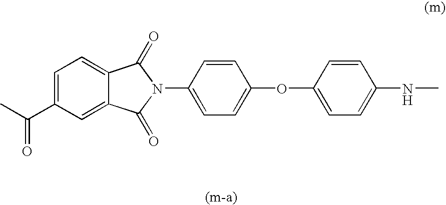

and/or the corresponding amide-amic acid containing recurring unit:

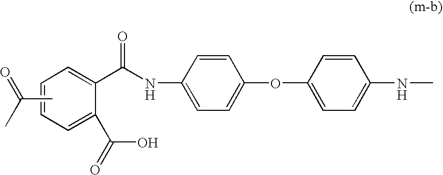

wherein the attachment of the two amide groups to the aromatic ring as shown in (m-b) will be understood to represent the 1,3 and the 1,4 polyamide-amic acid configurations; and

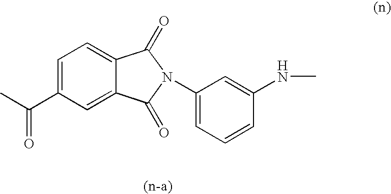

and/or the corresponding amide-amic acid containing recurring unit:

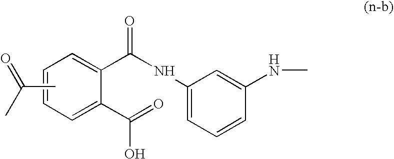

wherein the attachment of the two amide groups to the aromatic ring as shown in (n-b) will be understood to represent the 1,3 and the 1,4 polyamide-amic acid configurations.

Very preferably, the aromatic polyamide-imide comprises more than 90 wt % of recurring units (R3). Still more preferably, it contains no recurring unit other than recurring units (R3). Polymers commercialized by Solvay Advanced Polymers, L.L.C., as TORLON® polyamide-imides comply with this criterion.

The aromatic polyamide-imide can be notably manufactured by a process including the polycondensation reaction between at least one acid monomer chosen from trimellitic anhydride and trimellitic anhydride monoacid halides and at least one comonomer chosen from diamines and diisocyanates.

Among the trimellitic anhydride monoacid halides, trimellitic anhydride monoacid chloride is preferred.

The comonomer comprises preferably at least one aromatic ring. Besides, it comprises preferably at most two aromatic rings. More preferably, the comonomer is a diamine. Still more preferably, the diamine is chosen from the group consisting of 4,4′-diaminodiphenylmethane, 4,4′-diaminodiphenylether, m-phenylenediamine and mixtures thereof.

For the purpose of the invention, the term “polyaryletherketone (PAEK)” is intended to denote any polymer, comprising recurring units (R″), more than 50 wt % of said recurring units are recurring units (k-A), (k-B) and/or (k-C):

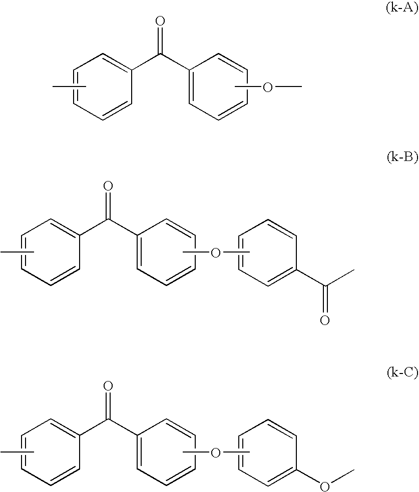

wherein the attachment of the ketone and/or ether groups to the aromatic ring as shown in (k-A), (k-B) and (k-B) will be understood to represent, independently at each occurrence, each of the possible ortho, meta and para configurations.

Preferably at least 70 wt %, more preferably at least 80 wt % of the recurring units (R″) of the polyaryletherketone (PAEK) suitable for the core-shell particles of the invention are recurring units (k-A), (k-B) and/or (k-C). Excellent results have been obtained with polyaryletherketone (PAEK) comprising no recurring units other than recurring units (k-A), (k-B) and/or (k-C).

Polyaryletherketones (PAEK) are generally crystalline aromatic polymers, readily available from a variety of commercial sources. Methods for their preparation are well known, including the processes described for example in U.S. Pat. Nos. 3,441,538, 3,442,857, 3,516,966, 4,396,755 and 4,816,556. The polyaryletherketones (PAEK) have preferably reduced viscosities in the range of from about 0.8 to about 1.8 dl/g as measured in concentrated sulfuric acid at 25 C and at atmospheric pressure.

Preferably the polyaryletherketone (PAEK) is chosen among polyetheretherketones (PEEK) and polyetherketoneketone (PEKK).

A polyetheretherketone (PEEK) is a polyaryletherketone (PAEK) wherein more than 50 wt % of recurring units (R″) are recurring units (k-C).

A polyetherketoneketone (PEKK) is a polyaryletherketone (PAEK) wherein more than 50 wt % of recurring units (R″) are recurring units (k-B).

Non limitative examples of commercially available polyaryletherketone (PAEK) resins suitable for the invention include the VICTREX® PEEK polyetheretherketone, from Victrex Manufacturing Ltd. (UK), which is a polymer, the recurring units of which are recurring units (k-cl):

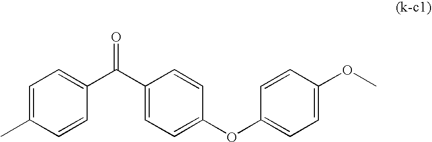

The terms “liquid crystal polymers (LCP)” encompasse notably fully aromatic liquid crystalline polyesters.

Fully aromatic liquid crystalline polyesters can be produced in the melt by three main processes:
direct esterification of optionally substituted phenols with aromatic carboxylic acids in the presence of catalysts such as titanium tetrabutyrate or dibutyl tin diacetate at high temperature;
reaction between phenyl esters of aromatic carboxylic acids with relevant optionally substituted phenols;
acidolysis of phenolic acetates with aromatic carboxylic acids.

Non limitative examples of commercially available fully aromatic liquid crystalline polyesters are notably VECTRA® LCP from Hoechst-Celanese and XYDAR® LCP from Solvay Advanced Polymers.

VECTRA® LCP is typically synthesized from 4-hydrobenzoic acid and 6-hydroxy-2-naphtoic acid; VECTRA® LCP is a polymer the recurring units of which are recurring units (lcp-A) and (lcp-B), typically in a ratio (lcp-A)/(lcp-B) of about 25/75:

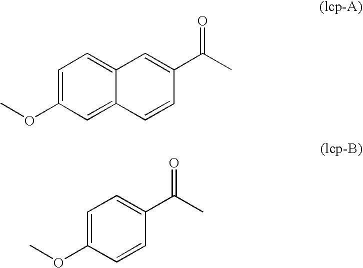

XYDAR® LCP is typically synthesized from 4-hydroxybenzoic acid, 4,4′-dihydroxy-1,1′-biphenyl, and terephtalic acid; the basic structure can be modified by using other monomers such as isophtalic acid or 4-aminobenzoic acid; XYDAR® LCP is generally a polymer the recurring units of which are recurring units (lcp-C), (lcp-D) and (lcp-B), typically in a ratio [(lcp-C)+(lcp-D)]/(lcp-B) of about ½:

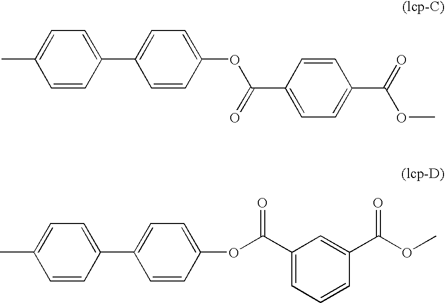

For the purpose of the invention, the terms “aromatic sulfone polymer (P)” are intended to denote any polymer, comprising recurring units (R), at least 50% wt of said recurring units comprising at least one group of formula 1:

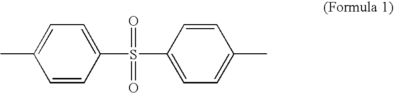

In a first variant of the invention, at least 50% wt of the recurring units (R) of aromatic sulfone polymer (P) are recurring units (R4), in their imide form (R4-A) and/or amic acid forms [(R4-B) and (R4-C)]

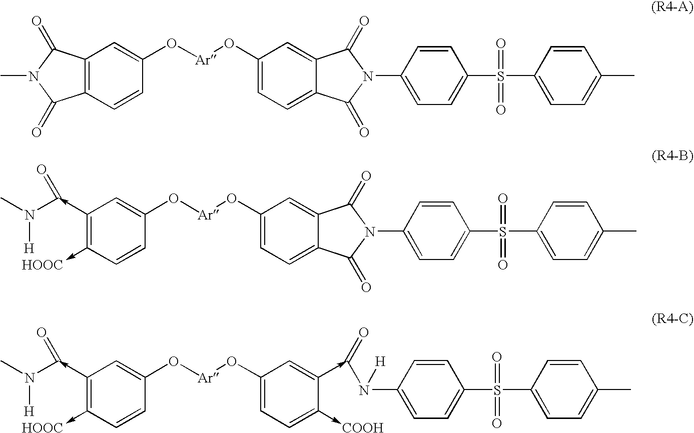

wherein
the → denotes isomerism so that in any recurring unit the groups to which the arrows point may exist as shown or in an interchanged position;
Ar″ is chosen among the following structures

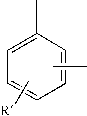

with the linking groups being in ortho, meta or para position and R′ being a hydrogen atom or an alkyl radical comprising from 1 to 6 carbon atoms,

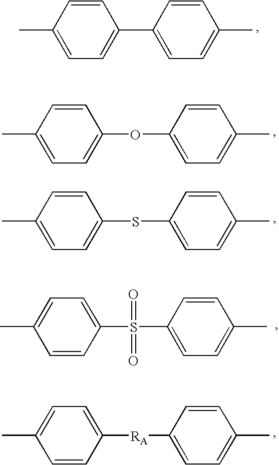

with R_{A} being an aliphatic divalent group of up to 6 carbon atoms, such as methylene, ethylene, isopropylene and the like,
and mixtures thereof.

In a second preferred variant of the invention, at least 50% wt of the recurring units (R) of aromatic sulfone polymer (P) are recurring units (R5) and/or recurring units (R6):

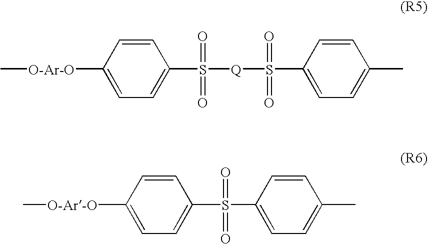

wherein:
Q is a group chosen among the following structures:

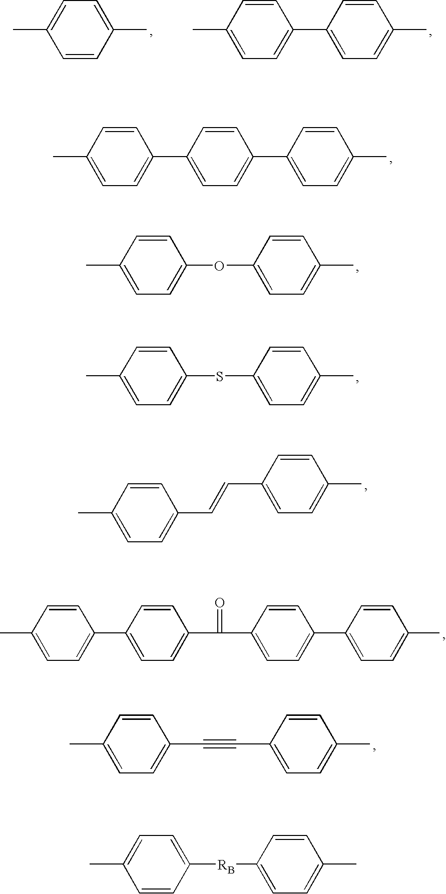

with R_{B} being:

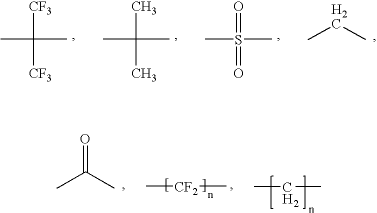

with n=integer from 1 to 6, or an aliphatic divalent group, linear or branched, of up to 6 carbon atoms;
and mixtures thereof;
Ar is a group chosen among the following structures:

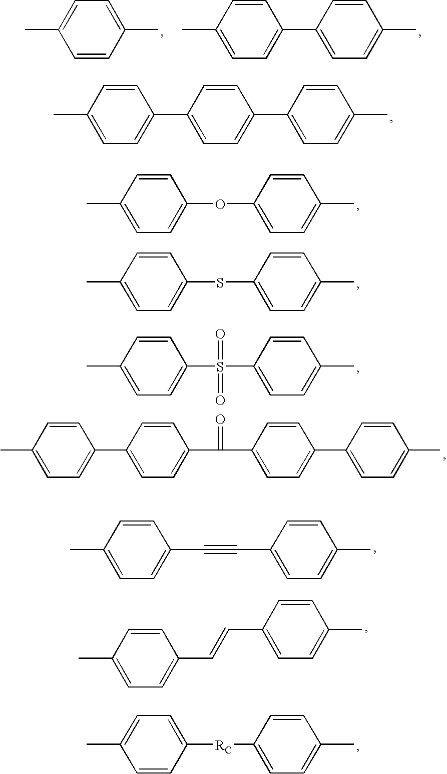

with R_{C}
being:

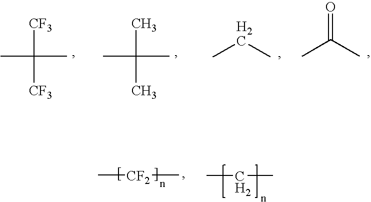

with n=integer from 1 to 6, or an aliphatic divalent group, linear or branched, of up to 6 carbon atoms;
and mixtures thereof;
Ar′ is a group chosen among the following structures:

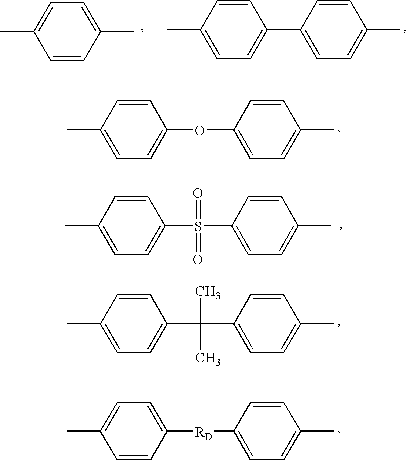

with R_{D} being:

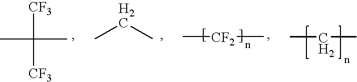

with n=integer from 1 to 6, or an aliphatic divalent group, linear or branched, of up to 6 carbon atoms;
and mixtures thereof.

Recurring units (R5) are preferably chosen from:

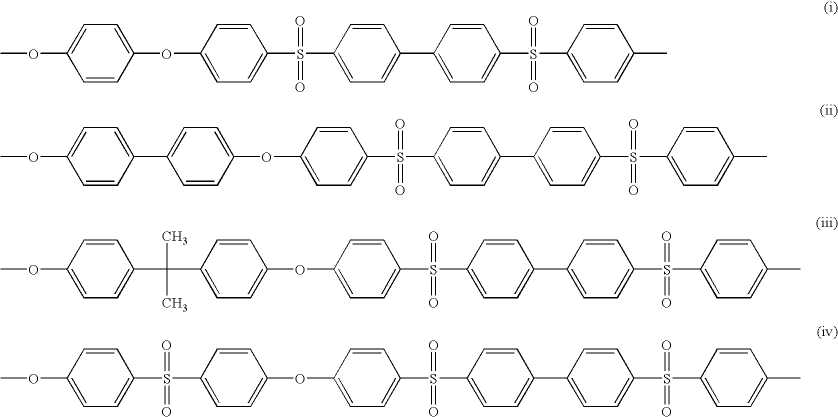

and mixtures thereof.

Recurring units (R6) are preferably chosen from:

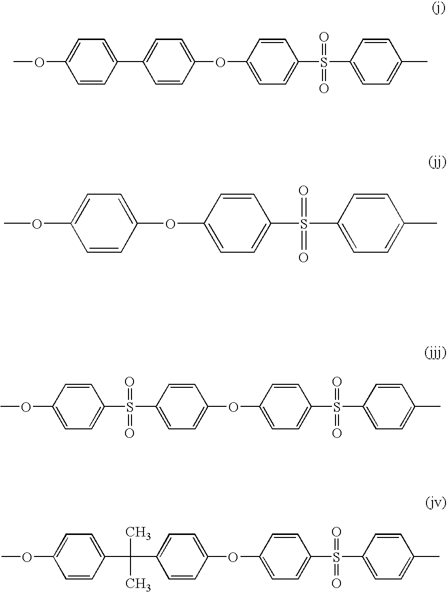

and mixtures thereof.

Most preferably, recurring units (R6) are units (j) as above detailed.

Aromatic sulfone polymer (P) according to the second preferred variant of the invention comprises at least 50% wt. preferably 70% wt. more preferably 75% wt of recurring units (R5) and/or (R6), still more preferably, it contains no recurring unit other than recurring units (R5) and/or (R6).

Good results were obtained with aromatic sulfone polymer (P) the recurring units of which are recurring units (ii) (polybiphenyldisulfone, herein after), with aromatic sulfone polymer (P) the recurring units of which are recurring units (j) (polyphenylsulfone or PPSU, hereinafter), with aromatic sulfone polymer (P) the recurring units of which are recurring units (jj) (polyetherethersulfone, hereinafter), with aromatic sulfone polymer (P) the recurring units of which are recurring units (jjj) and, optionally in addition, recurring units (jj) (polyethersulfone, hereinafter), and with aromatic sulfone polymer (P) the recurring units of which are recurring units (jv) (polysulfone, hereinafter).

Polyphenylsulfone is notably available as RADEL® R PPSU from Solvay Advanced Polymers, L.L.C. Polysulfone is notably available as UDEL® PSF from Solvay Advanced Polymers, L.L.C. Polyethersulfone is notably available as RADEL® A PES from Solvay Advanced Polymers, L.L.C.

Preferably, aromatic sulfone polymer (P) according to the second preferred variant of the invention advantageously comprises at least 50% wt. preferably 70% wt. more preferably 75% wt of recurring units (R6), still more preferably, it contains no recurring unit other than recurring units (R6).

More preferably, aromatic sulfone polymer (P) is chosen among the group consisting of polysulfone, polyphenylsulfone, polyethersulfone, copolymers and mixtures thereof.

Most preferably, aromatic sulfone polymer (P) is a polyphenylsulfone, i.e. a polymer the recurring units thereof are recurring units (j) as above detailed.

The TFE polymer (F) is advantageously chosen among homopolymers of tetrafluoroethylene (TFE) or copolymers of TFE with at least one ethylenically unsaturated comonomer [comonomer (CM)], said comonomer being present in the TFE copolymer in an amount from 0.01 to 3% by moles, preferably from 0.01 to 1% by moles, with respect to the total moles of TFE and comonomer (CM).

In the rest of the text, the expressions “ethylenically unsaturated comonomer” and “comonomer (CM)” are understood, for the purposes of the present invention, both in the plural and the singular, that is to say that they denote both one or more than one comonomer (CM).

The comonomer (CM) can comprise at least one fluorine atom (fluorinated comonomer) or can be free of fluorine atoms (hydrogenated comonomer).

Among hydrogenated comonomers mention can be notably made of ethylene; propylene; acrylic monomers, such as for instance methylmethacrylate, (meth)acrylic acid, butylacrylate, hydroxyethylhexylacrylate; styrene monomers, such as for instance styrene.

Non limitative examples of suitable fluorinated comonomers are notably:
C₃-C₈ perfluoroolefins, such as hexafluoropropene;
C₂-C₈ hydrogenated fluoroolefins, such as vinyl fluoride (VF), vinylidene fluoride (VDF), 1,2-difluoroethylene and trifluoroethylene;
perfluoroalkylethylenes complying with formula CH₂═CH—R_{f0}, in which R_{f0} is a C₁-C₆ perfluoroalkyl;
chloro- and/or bromo- and/or iodo-C₂-C₆ fluoroolefins, like chlorotrifluoroethylene (CTFE);
(per)fluoroalkylvinylethers complying with formula CF₂═CFOR_{f1} in which R_{f1} is a C₁-C₆ fluoro- or perfluoroalkyl, e.g. CF₃, C₂F₅, C₃F₇;
CF₂═CFOX₀ (per)fluoro-oxyalkylvinylethers, in which X₀ is a C₁-C₁₂ alkyl, or a C₁-C₁₂ oxyalkyl, or a C₁-C₁₂ (per)fluorooxyalkyl having one or more ether groups, like perfluoro-2-propoxy-propyl;
(per)fluoro-oxyalkylvinylethers complying with formula CF₂═CFOCF₂OR_{f2} in which R_{f2} is a C₁-C₆ fluoro- or perfluoroalkyl, e.g. —CF₃, —C₂F₅, —C₃F₇ or a C₁-C₆ (per)fluorooxyalkyl having one or more ether groups, like —C₂F₅—O—CF₃;
functional (per)fluoroalkylvinylethers complying with formula CF₂═CFOY₀, in which Y₀ is a C₁-C₁₂ alkyl or (per)fluoroalkyl, or a C₁-C₁₂ oxyalkyl, or a C₁-C₁₂ (per)fluorooxyalkyl having one or more ether groups and Y₀ comprising a carboxylic or sulfonic acid group, in its acid, acid halide or salt form;
fluorodioxoles of formula:

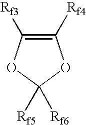

wherein each of R_{f3}, R_{f4}, R_{f5}, R_{f6}, equal of different each other, is independently a fluorine atom, a C₁-C₆ fluoro- or perfluoroalkyl, optionally comprising one or more oxygen atom, e.g. —CF₃, —C₂F₅, —C₃F₇, —OCF₃, —OCF₂CF₂OCF₃; preferably a fluorodioxole complying with formula here above, wherein R_{f3} and R_{f4} are fluorine atoms and R_{f5} and R_{f6} are perfluoromethyl groups (—CF₃), or a fluorodioxole complying with formula here above, wherein R_{f3}, R_{f5} and R_{f6} are fluorine atoms and R_{f4} is a perfluoromethoxy group (—OCF₃).

The fluorinated comonomer can further comprise one or more other halogen atoms (Cl, Br, I). Shall the fluorinated comonomer be free of hydrogen atom, it is designated as per(halo)fluorocomonomer. Shall the fluorinated monomer comprise at least one hydrogen atom, it is designated as hydrogen-containing fluorinated comonomer.

The comonomer (CM) is preferably a fluorinated comonomer, more preferably a per(halo)fluorocomonomer.

Most preferably, the comonomer (CM) is chosen among hexafluoropropylene, perfluoromethylvinylether, perfluoroethylvinylether, perfluoropropylvinylether, perfluorodioxole of formula:

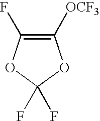

and mixtures thereof.

The polymer (F) is advantageously non melt-processable.

For the purposes of the present invention, by the term “non melt-processable” is meant that the polymer (F) cannot be processed (i.e. fabricated into shaped articles such as films, fibers, tubes, wire coatings and the like) by conventional melt extruding, injecting or casting means. Such typically requires that the dynamic viscosity at a shear rate of 1 s⁻¹ and at a temperature exceeding melting point of roughly 30° C., preferably at a temperature of Tₘ₂+(30±2° C.), exceed 10⁶ Pa×s, when measured with a controlled strain rheometer, employing an actuator to apply a deforming strain to the sample and a separate transducer to measure the resultant stress developed within the sample, and using the parallel plate fixture.

The core-shell particles of the invention advantageously comprise at least 1, preferably at least 2% wt. more preferably at least 3% wt. still more preferably at least 5% wt of TFE polymer (F) based on the total weight of core-shell particles.

The core-shell particles of the invention advantageously comprise at most 99% wt. preferably at most 97.5% wt, more preferably at most 95% wt of TFE polymer (F) based on the total weight of core-shell particles.

Good results have been obtained with core-shell particles comprising from 5 to 95 wt % of polymer (F) based on the total weight of the core-shell particles.

Core-shell particles comprising from 45 to 95 wt % of polymer (F) based on the total weight of the core-shell particles are to be preferred in view of providing ingredients/additives for polymer compositions.

Particles having nanometric dimension (i.e. average primary particle size of less than 1 μm), are generally referred as nanoparticles.

The cores consisting essentially of polymer (F) suitable for the core-shell particle of the invention have an average primary particle size of less than 100 nm, preferably of less than 90 nm, more preferably of less than 80 nm, most preferably of less than 70 nm.

The cores consisting essentially of polymer (F) suitable for the core-shell particle of the invention have an average primary particle size of advantageously more than 2 nm, preferably of more than 5 nm, more preferably of more than 10 nm, even more preferably of more than 15 nm, most preferably of more than 20 nm.

Good results have been obtained with a core-shell particle having a core of average primary particle size of more than 10 nm and less than 100 nm.

Excellent results have been obtained with core-shell particles having a core of average primary particle size of more than 20 nm and less than 70 nm.

The average primary particle size of the cores can be measured by photon correlation spectroscopy (PCS) (method also referred to as dynamic laser light scattering (DLLS) technique) according to the method described in B. Chu “Laser light scattering” Academic Press, New York (1974), following ISO 13321 Standard.

It is well-known to the skilled in the art that the PCS gives an estimation of the average hydrodynamic diameter. To the purpose of this invention, the term “average size” is to be intended in its broadest meaning connected with the determination of the hydrodynamic diameter. Therefore, this term will be applied with no limit to the shape or morphology of the polymer (F) cores (cobblestone, rod-like, spherical, and the like).

It should be also understood that, following the purposes of ISO 13321 Standard, the term “average particle size” of primary particles is intended to denote the harmonic intensity-averaged particle diameter X_{PCS}, as determined by equation (C.10) of annex C of ISO 13321.

As an example, the average primary particle size can be measured by using a Malvern Zetasizer 3000 HS equipment at 90° scattering angle, using a 10 mV He—Ne laser source and a PCS software (Malvern 1.34 version). Primary average particle size is preferably measured on latex specimens, as obtained from microemulsion polymerization, suitably diluted with bidistilled water and filtered at 0.2 μm on Millipore filter.

For the avoidance of doubt, within the context of this invention, the term primary particle is intended to denote nanoparticles of polymer (F) which cannot be analyzed in agglomerations of smaller particles; primary particle are generally obtained during polymer (F) manufacture, as latex or dispersion in water.

The invention also relates to a process for manufacturing the core-shell particle as above described.

The core-shell particles of the invention can be manufactured by various processes. Preferably they are obtained by the process of the invention.

Thus, an object of the invention is a process for manufacturing core-shell particles comprising:
a core consisting essentially of at least one TFE polymer [polymer (F)], said core having an average primary particle size of less than 100 nm
a shell consisting essentially of at least one high performance polymer [polymer (HPP)],
   said process comprising
(i) preparing a dispersion of polymer (F) nanoparticles in water [dispersion (D)];
(ii) dissolving polymer (HPP) in a solvent (SV), to give a polymer (HPP) solution [solution (S)];
(iii) adding said solution (S) to said dispersion (D).

By “dispersion” is meant that the polymer (F) particles are stably dispersed in the aqueous medium, so that settling of the particles does not occur within the time when the dispersion will be used. Such dispersions can be obtained directly by the process known as dispersion or emulsion polymerization (i.e. latex), optionally followed by concentration and/or further addition of surfactant.

Otherwise, dispersions can be prepared by any means known to those skilled in the art. The dispersions are usually prepared by means of size-reduction equipment, such as, for example, a high-pressure homogenizer, a colloid mill, a fast pump, a vibratory agitator or an ultrasound device. The dispersions are preferably prepared by means of a high-pressure homogenizer or colloid mill and in a particularly preferred way by means of a high-pressure homogenizer.

Most preferably the dispersion (D) is obtained from a process comprising a microemulsion polymerization step, comprising notably:
a) preparing an aqueous microemulsion of perfluoropolyether (PFPE) in water with a fluorinated surfactant;
b) polymerizing a monomer mixture comprising TFE in a aqueous medium comprising said microemulsion and a water-soluble radical initiator.

Within the context of the present invention, the term perfluoropolyether (PFPE) is intended to denote an oligomer comprising recurring units (R*), said recurring units comprising at least one ether linkage in the main chain and at least one fluorine atom (fluoropolyoxyalkene chain).

Preferably the recurring units R* of the (per)fluoropolyether are selected from the group consisting of:
(I) —CFX—O—, wherein X is —F or —CF₃; and
(II) —CF₂—CFX—O—, wherein X is —F or —CF₃; and
(III) —CF₂—CF₂—CF₂—O—; and
(IV) —CF₂—CF₂—CF₂—CF₂—O—; and
(V) —(CF₂)ⱼ—CFZ-O— wherein j is an integer chosen from 0 and 1 and Z is a fluoropolyoxyalkene chain comprising from 1 to 10 recurring units chosen among the classes (I) to (IV) here above;
   and mixtures thereof.

The microemulsions of PFPE used in the process as above described are notably described in U.S. Pat. Nos. 4,864,006 and 4,990,283, whose disclosures are herein incorporated by reference. Otherwise, microemulsion of PFPE having non reactive end groups or end groups optionally containing 1 or more atoms of H, Cl instead of fluorine are described in U.S. Pat. No. 6,297,334.

The molecular weight of perfluoropolyethers (PFPE) which can be used can also be lower than 500, for example 300 as number average molecular weight. The microemulsions obtained with the use of PFPE having a low molecular weight, in the range of 350-600, preferably 350-500, can be used advantageously in the applications wherein their quantitative removal is required.

The surfactant which can be used both for preparing the microemulsion and during the polymerization, are (per)fluorinated surfactant known in the prior art and in particular are those described in the cited patents or those having one end group wherein one or more fluorine atoms are substituted by chlorine and/or hydrogen. Among (per)fluorinated surfactant, anionic (per)fluorinated surfactant, having a (per)fluoropolyether or (per)fluorocarbon structure, having for example carboxylic or sulphonic end groups salified with ammonium ions, alkaline or alkaline-earth metals, cationic (per)fluorinated surfactant, for example quaternary ammonium salts, and non ionic (per)fluorinated surfactants, can be mentioned. These surfactant can also be used in admixture. Anionic (per)fluorinated surfactant are preferred and those having salified carboxylic end groups are more preferred.

Optionally in the process for preparing polymer (F) nanoparhicles, iodinated and brominated chain transfer agents can be used. R_{f}^{□}I₂ can for example be mentioned, wherein R_{f}^{□} is a divalent perfluorocarbon moiety comprising from 4 to 8 carbon atoms

Processes comprising a microemulsion polymerization step as described in U.S. Pat. No. 6,297,334, whose disclosures are herein incorporated by reference, are particularly suitable for preparing dispersion in water of polymer (F) nanoparticles having an average primary particle size of less than 100 nm.

The dispersion (D) has advantageously a polymer (F) content of less than 30% wt. preferably of less than 25% wt. more preferably of less than 15% wt. still more preferably of less than 10% wt. most preferably of less than 5% wt.

Excellent results have been obtained with dispersions (D) having a polymer (F) content of less than 3% wt.

The content of polymer (F) of the dispersion (D) can be determined by weight loss at 150° C. for 1 hour, by weighting about 20 grams of the dispersion in a glass beaker, putting it in a oven for 1 hour at 150° C., according to the following formula:

$$Polymer ( F ) content = \frac{weight after drying}{initial latex weight} \cdot 100$$

Thus, the dispersions of polymer (F) nanoparticles as obtained from the processes as above described can be advantageously concentrated and/or diluted to obtain the desired polymer (F) content. Preferably, the dispersions as above described are diluted by addition of water.

Within the context of the present invention, the term “solvent (SV)” encompasses both a solvent used alone and mixtures of solvents which are able to dissolve the polymer (HPP).

The specific choice of the solvent will depends upon the nature of the polymer (HPP).

The solvent (SV) capable of dissolving the polymer (HPP) is preferably chosen from liquids having a solubility parameter (a definition, and experimental values, for which is found in “Properties of Polymers”, D. W. Van Krevelen, 1990 Edition, pp. 200-202, and in “Polymer Handbook”, J. Brandrup and E. H. Immergut, Editors, Second Edition, p. IV-337 to IV-359) close to the solubility parameter of the polymer (HPP).

Non limitative examples of suitable solvents (SV) for polymer (HPP) are notably ethyl acetate (EAc), methylethyl ketone (MEK), N-methylpyrrolidone (NMP), N,N-dimethylformamide (DMF), N,N-dimethylacetamide (DMAC), dimethylsulfoxide (DMSO), cresylic acid, sulfolane, formamide or combinations thereof, and combinations of above mentioned solvents or mixtures with acetone, methanol, ethanol, isopropanol and the like.

Preferably, the solvent (SV) is chosen among N-methylpyrrolidone (NMP), N,N-dimethylformamide (DMF), N,N-dimethylacetamide (DMAC), sulfolane and their mixtures.

Preferably the solvent (SV) is at least partially miscible with water.

A solvent (SV) is understood to be at least partially miscible with water when its solubility in water is generally of more than 10% v/v at room temperature (25° C.), that is to say that one uniform liquid phase is thus formed.

The Applicant thinks without this limiting the scope of the invention that the use of a solvent (SV) at least partially miscible with water acts to facilitate the proper combination of the polymer (HPP) added to the polymer (F) nanoparticles dispersion in water.

It has been found useful within the context of the process of the invention to combine the solvent (SV) as above detailed with another organic liquid (OL), which is miscible with water in all proportions at room temperature (25° C.).

The organic liquid (OL), which is generally not capable of dissolving polymer (P), encompass either pure substances or mixtures of substances.

Non limitative examples of suitable organic liquids to be used within the context of the invention are notably acetone, methanol, ethanol, isopropanol and the like.

Preferably the organic liquid (OL) is chosen among acetone and ethanol.

Preferably, the mixture of the solvent (SV) with the organic liquid (OL) is miscible with water; it is generally understood that said mixture is miscible with water when it can form a unique liquid phase with water in all proportions at room temperature (25° C.).

The solution (S) has advantageously a polymer (HPP) concentration of less than 20% wt. preferably less than 10% wt. more preferably less than 5% wt. most preferably less than 4% wt.

The solution (S) has advantageously a polymer (HPP) concentration of more than 0.01% wt. preferably more than 0.05% wt. more preferably more than 0.1% wt. most preferably more than 0.25% wt. most preferably more than 0.5% wt.

The terms “concentration of the solution (S)” is intended to denote the weight percent of the polymer (HPP) with respect to the total weight of the solution, comprising the solvent (SV) and optionally the organic liquid (OL).

Good results have been obtained when using solution (S) having polymer (HPP) concentrations of 0.5 to 4% wt.

Solution (S) having polymer (HPP) concentrations of about 2% wt are particularly advantageous in view of their stability and the economy of the process compromise.

Dissolving the polymer (HPP) in the solvent can be accomplished by using standard techniques well-known to the skilled in the art.

Preferably, dissolving is carried out by mixing the polymer (HPP) and the solvent under stirring. Polymer (HPP) and the solvent can be notably mixed in stirred tank vessels provided with a blade or shaft stirrer or impeller.

Finally, according to the process of the invention, the solution (S) is added to the dispersion (D).

The solution (S) is preferably added to the dispersion (D) under stirring.

The water of the dispersion (D) advantageously acts as a non-solvent for the polymer (HPP), thus enabling its precipitation; the polymer (F) nanoparticles advantageously represents seed sites on which the polymer (HPP) preferably precipitates.

The Application has found that a highly homogeneous deposition of the polymer (HPP) on the polymer (F) nanoparticles can be obtained when the solution (S) is added to the dispersion at a rate not exceeding 20 g of polymer (HPP)/[g of polymer (F)×h].

Thus, preferably, the solution (S) is added at a rate of less than 15, preferably of less than 10, most preferably of less than 5 g of polymer (HPP)/[g of polymer (F)×h].

The core-shell particles can be advantageously recovered from the water and the solvent by methods well-known in the art, like, for example, filtration, centrifugation, coagulation, settlement and decantation and the like, to separate out dry core-shell particles, which can be further dried by standard techniques.

Thus the process of the invention can optionally comprise a separation step and/or a drying step.

The core-shell particle as above described can be advantageously used as ingredients or additives in polymer compositions; the Applicant has found, without its findings limiting the scope of the invention, that when using such core-shell particles, a better dispersion of polymer (F) nanoparticles in a polymer composition can be achieved.

Thus the patent application also relates to the use of core-shell particles as above described for improving dispersion of polymer (F) nanoparticles in a polymer composition. Said polymer composition advantageously comprises at least one high performance polymer (HPP) as above described.

When core-shell particles are used as ingredients/additives, they are used in an amount so that in the final composition there is an amount of polymer (F) of at least 0.01% wt. preferably of at least 0.05% wt. most preferably of at least 0.1% wt. based on the total weight of the final composition.

When core-shell particles are used as ingredients/additives, they are used in an amount so that in the final composition there is an amount of polymer (F) of at most 30% wt. preferably of at most 20% wt. most preferably of at most 10% wt. based on the total weight of the final composition.

The core-shell particles as above described are used notably as additive in polymer compositions for improving flammability behaviour, friction and wear properties, typically without negatively affect transparency.

The present invention also relates to a polymer composition comprising core-shell particles as above described.

Advantageously the polymer composition comprises in addition to the core-shell particles of the invention at least one additional polymer component.

Preferably the additional polymer component comprises at least one high performance polymer (HPP) as above defined.

The additional polymer component may be the same polymer (HPP) which the shell of the core-shell particles of the invention consists essentially of or may be a different polymer (HPP).

Preferably, the additional polymer component is a polymer (HPP) which is miscible with the polymer (HPP) which the shell consists essentially of.

For the purpose of the invention, the term “miscible” should be understood to mean that the polymer (HPP) of the additional polymer component and the polymer (HPP) of the shell of the core-shell particles yield in the composition according to the invention a single homogeneous phase, showing only one glass transition temperature.

Most preferably, the additional polymer component is a polymer (HPP) which is the same polymer (HPP) which the shell consists essentially of.

The compositions of the invention advantageously comprises at least at least 0.01% wt. preferably of at least 0.05% wt. most preferably of at least 0.1% wt. based on the total weight of the composition, of TFE polymer (F) derived from core-shell particles of the invention.

The compositions of the invention advantageously comprises at least at most 30% wt. preferably of at most 20% wt. most preferably of at most 10% wt. based on the total weight of the composition, of TFE polymer (F) derived from core-shell particles of the invention.

Concentrations of the polymer (F) above 30 wt %, with respect to the total weight of the composition are undesirable since these amounts can adversely affect the moldability and can create a pearlescent effect, making color matching a problem.

The compositions of the invention can be manufactured by standard processes well-known to those skilled in the art, said processes comprising mixing the core-shell particle as above detailed and the other ingredients.

According to a preferred variant of the invention, said process comprises advantageously mixing by dry blending and/or melt compounding. Preferably, the process comprises melt compounding.

Advantageously, the core-shell particles and the other ingredients are melt compounded in continuous or batch devices. Such devices are well-known to those skilled in the art.

Examples of suitable continuous are notably screw extruders. Thus, the core-shell particles and the other ingredients are advantageously fed in an extruder and the composition is extruded.

This operating method can be applied either with a view to manufacturing finished product such as, for instance, hollow bodies, pipes, laminates, calendared articles, or with a view to having available granules containing the desired composition, optionally additives and fillers, in suitable proportions in the form of pellets, which facilitates a subsequent conversion into finished articles. With this latter aim, the composition of the invention is advantageously extruded into strands and the strands are chopped into pellets.

Optionally, fillers, heat stabilizer, anti-static agents, extenders, reinforcing agents, organic and/or inorganic pigments like TiO₂, carbon black, acid scavengers, such as MgO, flame-retardants, smoke-suppressing agents may be added to the composition during said compounding step.

Still object of the invention is an article comprising the core-shell particles as above detailed or the composition as above defined.

Advantageously the article is an injection molded article, an extrusion molded article, a machined article, a coated article or a casted article.

Non-limitative examples of articles are aircraft interior components, such as window covers, ceiling panels, sidewall panels and wall partitions, display cases, mirrors, sun visors, window shades, stowage bins, stowage doors, ceiling overhead storage lockers, serving trays, seat backs, cabin partitions, and ducts.

### Analytical Methods

### Photon Correlation Spectroscopy (PCS)

The average particle size of the polymer lattices and core-shell particles dispersions has been measured by photon correlation spectroscopy (method also referred to as dynamic laser light scattering (DLLS) technique) according to the method described in B. Chu “Laser light scattering” Academic Press, New York (1974), following ISO 13321 Standard, using a Malvern Zetasizer 3000 HS at 90° scattering angle, using a 10 mV He—Ne laser source and a PCS software (Malvern 1.34 version).

### PTFE Content of the Aqueous Dispersions

The content of TFE of the dispersions has been determined by weight loss at 150° C. for 1 hour, by weighting about 20 grams of the dispersion in a glass beaker, putting it in a oven for 1 hour at 150° C., and calculating the PTFE content according to the following formula:

$$PTFE content = \frac{weight after drying}{initial dispersion weight} \cdot 100$$

### Differential Scanning Calorimetry

DSC measurements have been performed at a heating rate of 110° C./min, according to ASTM D 3418.

### PTFE Content of Core-Shell Particles

PTFE content in core-shell particles has been estimated either by fluorine elemental analysis or by TGA measurements.

In the latter case, a sample of the core-shell particles was analysed by TGA up to a final temperature of 800° C., in order to achieve complete decomposition of the polymer components (the TFE nanoparticles and the HPP polymer), which showed separated temperature windows of decomposition. PTFE weight content of the core-shell particles was thus determined as the weight fraction lost at the PTFE decomposition temperature.

### Raw Materials

ALGOFLON® MD10, NE5 OP341, NE10 OP201 PTFE aqueous dispersions, obtained from microemulsion polymerization, are available from Solvay Solexis S.p.A.

TORLON® TF4000 polyamideimide is commercially available from Solvay Advanced Polymers, L.L.C.

RADEL® R5800P PPSU is commercially available from Solvay Advanced Polymers, L.L.C.

RADEL® A PES is commercially available from Solvay Advanced Polymers, L.L.C.

### EXAMPLE 1

A 3 wt % solution of TORLON® TF4000 polyamideimide (PAI) in 1-methyl-2-pyrrolidone (NMP) and acetone was prepared by dissolving under stirring 5.0 g of PAI in 108.32 g of NMP and 53.35 g acetone at 50° C. (67/33 NMP/acetone weight ratio).

A one-liter, 3-neck round bottom reaction flask was equipped through its center neck with an overhead stirrer attached to a glass paddle agitator. A thermocouple attached to a temperature controller was attached to one of the side necks, and a 250 ml dropping funnel was installed in the other side neck of the round bottom flask for addition of the PAI/NMP/acetone solution.

A 2 wt % nano-PTFE seed dispersion was prepared by diluting 25 ml of ALGOFLON® MD10 PTFE aqueous dispersion (0.3476 g/ml PTFE; 44 nm average primary particle size) with 400 ml of de-ionized water. This dispersion was then charged to the round bottom flask and heated to 80° C. under agitation.

From the 250 ml dropping funnel, 14.5 g of the 3 wt % PAI/NMP/acetone solution were then charged drop-wise to the nano-PTFE dispersion. After completion of the addition (about 30 minutes), the heating was stopped and the resulting core-shell latex was kept under constant agitation until the temperature reach 25° C.

The dispersion obtained had a particles size of 127 nm and was stable for at least 3 days without showing irreversible coagulation and formation of sediment. The core-shell particles were coagulated keeping the dispersion at −18° C. until complete solidification. The wet coagulum obtained at room temperature was separated from the mother liquor by vacuum filtration through a 10 μm pore size filter.

The recovered powder was then dried overnight in a vacuum oven at 120° C. The core-shell particles were recovered as a compact cake and ground in a lab scale high shear blade mill. The composite powder, classified using a 500 μm stainless steel screen, has a particle size of 75 μm. The PTFE content, measured by TGA, heating speed 10° C./min, was 95%.

### EXAMPLE 2

A 3 wt % solution of TORLON® TF4000 polyamideimide (PAI) in 1-methyl-2-pyrrolidone (NMP) and acetone was prepared by dissolving under stirring 5 g of PAI in 108.32 g of NMP and 53.35 g acetone at 50° C. (67/33 NMP/acetone weight ratio).

A one-liter, 3-neck round bottom reaction flask was equipped through its center neck with an overhead stirrer attached to a glass paddle agitator. A thermocouple attached to a temperature controller was attached to one of the side necks, and a 250 ml dropping funnel was installed in the other side neck of the round bottom flask for addition of the PAI/NMP/acetone solution.

A 0.15 wt % nano-PTFE seed dispersion was prepared by diluting 1.4 ml of ALGOFLON® MD1 PTFE aqueous dispersion (0.3476 g/ml PTFE; 44 nm average primary particle size) with 400 ml of de-ionized water. This dispersion was then charged to the round bottom flask and heated to 80° C. under agitation.

From the 250 ml dropping funnel, 86.9 g of the 3 wt % PAI/NMP/acetone solution were then charged drop-wise to the nano-PTFE dispersion. After completion of the addition (about 120 minutes), the heating was stopped and the resulting core-shell latex was kept under constant agitation until the temperature reach 25° C.

The dispersion obtained had a particles size of 128 nm and was stable for at least 3 days without showing irreversible coagulation and formation of sediment. The core-shell particles were coagulated keeping the dispersion at −18° C. until complete solidification. The wet coagulum obtained at room temperature was separated from the mother liquor by vacuum filtration through a 10 μm pore size filter.

The recovered powder was then dried overnight in a vacuum oven at 120° C. The core-shell particles were recovered as a compact cake and ground in a lab scale high shear blade mill. The composite powder, classified using a 500 μm stainless steel screen, has a particle size of 70 μm. The PTFE content, measured by TGA, heating speed 10° C./min, was 15%.

### EXAMPLE 3

A 3 wt % solution of TORLON® TF4000 polyamideimide in 1-methyl-2-pyrrolidone (NMP) and acetone was prepared by dissolving under stirring 5 g of PAI in 108.32 g of NMP and 53.35 g acetone at 50° C. (67/33 NMP/acetone weight ratio).

A one-liter, 3-neck round bottom reaction flask was equipped through its center neck with an overhead stirrer attached to a glass paddle agitator. A thermocouple attached to a temperature controller was attached to one of the side necks, and a 250 ml dropping funnel was installed in the other side neck of the round bottom flask for addition of the PAI/NMP/acetone solution.

A 2 wt % nano-PTFE seed dispersion was prepared by diluting 25 ml of ALGOFLON® MD10 PTFE aqueous dispersion (0.3476 g/ml PTFE; 44 nm average primary particle size) with 400 ml of de-ionized water. This dispersion was then charged to the round bottom flask and heated to 80° C. under agitation.

From the 250 ml dropping funnel, 29 g of the 3 wt % PAI/NMP/acetone solution were then charged drop-wise to the nano-PTFE dispersion. After completion of the addition (about 60 minutes), the heating was stopped and the resulting core-shell latex was kept under constant agitation until the temperature reach 25° C.

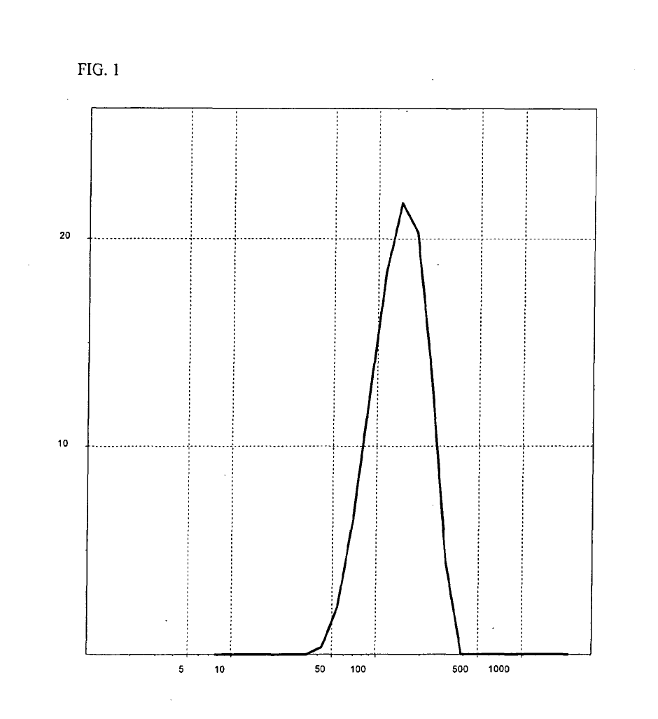

FIG. 1 depicts a PCS spectrum obtained analyzing the aqueous dispersion of the core-shell particles obtained from example 3. In the PSC spectrum, the abscissa represents the size of the particle in nanometer and the ordinate represents the normalized volume abundance of particles having said size. The dispersion obtained was found to have an average particles size of 128 nm and was stable for at least 3 days without showing irreversible coagulation and formation of sediment.

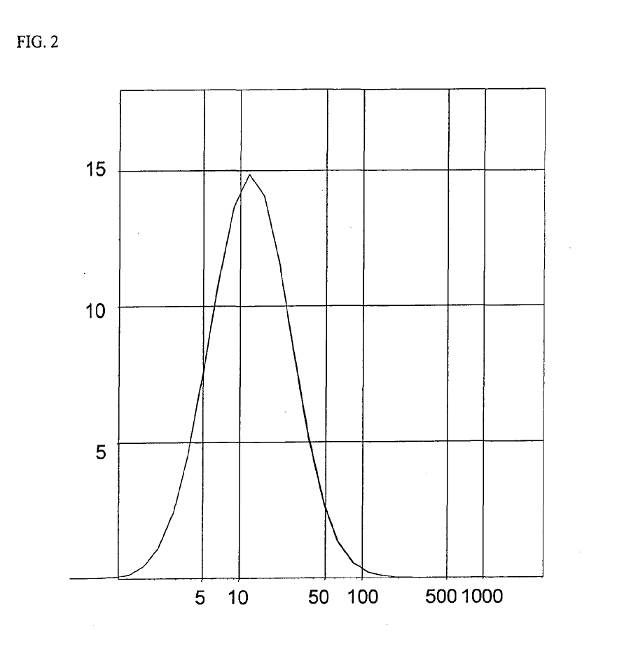

FIG. 2 depicts, for comparison, the PCS spectrum obtained for the ALGOFLON® MD10 PTFE aqueous dispersion.

PCS analysis confirmed that core-shell particles with size comprised between 120 and 140 nm can be obtained, endowed with a narrow size distribution. In addition, no trace of the initial PTFE latex was observed, thus indicating that the preparation process was highly efficient in producing core-shell particles.

The core-shell particles were coagulated keeping the dispersion at −18° C. until complete solidification. The wet coagulum obtained at room temperature was separated from the mother liquor by vacuum filtration through a 10 μm pore size filter.

The recovered powder was then dried overnight in a vacuum oven at 120° C. The core-shell particles were recovered as a compact cake and ground in a lab scale high shear blade mill. The composite powder, classified using a 500 μm stainless steel screen, has a particle size of 70 μm. The PTFE content, measured by TGA, heating speed 10° C./min, was 90.9%.

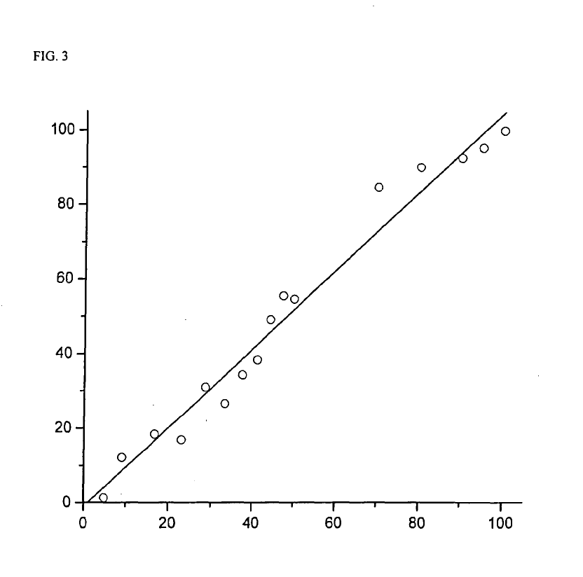

Other experiences were carried out for producing core-shell particles comprising a PTFE core and a PAI shell, following the synthetic method as described in examples 1 to 3, but using variable amounts of PTFE aqueous dispersion and of PAI solution. TGA determinations carried out on the so-obtained nano-composites demonstrated that the composition of the nanoparticles closely sticks to the composition of the feed mixture. FIG. 3 depicts the weight percent of PAI as determined by TGA analysis in the core-shell particles as a function of the weight percent of PAI in the raw materials (PAI solution plus PTFE aqueous dispersion) employed in the manufacture of said core-shell particles. Accordingly, it was demonstrated the ability to tune the core-shell particles composition to specific purposes in a wide range of compositions.

### EXAMPLE 4

A 2 wt % solution of RADEL® R5800P PPSU in 1-methyl-2-pyrrolidone (NMP) and acetone was prepared by dissolving under stirring 4.28 g of PPSU in 136.50 g of NMP and 73.50 g acetone at 50° C. (65/35 NMP/acetone weight ratio).

A one-liter, 3-neck round bottom reaction flask was equipped through its center neck with an overhead stirrer attached to a glass paddle agitator. A thermocouple attached to a temperature controller was attached to one of the side necks, and a 250 ml dropping funnel was installed in the other side neck of the round bottom flask for addition of the PPSU/NMP/acetone solution.

A 1 wt % nano-PTFE seed dispersion was prepared by diluting 23.4 ml of ALGOFLON® MD1 PTFE aqueous dispersion (0.2137 g/ml PTFE; 50 nm average primary particle size) with 476.6 ml of de-ionized water. This dispersion was then charged to the round bottom flask and heated to 50° C. under agitation.

From the 250 ml dropping funnel, 208.33 g of the 2 wt % PPSU/NMP/acetone solution were then charged drop-wise to the nano-PTFE dispersion. After completion of the addition (about 120 minutes), the heating was stopped and the resulting core-shell latex was kept under constant agitation until the temperature reach 25° C.

The dispersion obtained was stable for at least 3 days without showing irreversible coagulation and formation of sediment. The composite powder obtained by drying the dispersion in a vacuum oven at 120° C. was characterized by a PTFE content, measured by TGA, heating speed 10° C./min, of 54.5%.

### EXAMPLE 5

A 4 wt % solution of RADEL® R5800P PPSU in 1-methyl-2-pyrrolidone (NMP) and acetone was prepared by dissolving 8.56 g of PPSU in 170.52 g of NMP and 34.92 g ethanol at 50° C. (83/17 NMP/ethanol weight ratio).

A one-liter, 3-neck round bottom reaction flask was equipped through its center neck with an overhead stirrer attached to a glass paddle agitator. A thermocouple attached to a temperature controller was attached to one of the side necks, and a 250 ml dropping funnel was installed in the other side neck of the round bottom flask for addition of the PPSU/NMP/acetone solution.

A 1.25 wt % nano-PTFE seed dispersion was prepared by diluting 15 ml of ALGOFLON® MD10 PTFE aqueous dispersion (0.3476 g/ml PTFE; 44 nm average primary particle size) with 400 ml of de-ionized water. This dispersion was then charged to the round bottom flask and kept under agitation.

From the 250 ml dropping funnel, 130.62 g of the 4 wt % PPSU/NMP/acetone solution were then charged drop-wise to the nano-PTFE dispersion. After completion of the addition (about 90 minutes), a stable dispersion was obtained that did not shows sediment formation for at least 3 days.

The composite powder obtained by drying the dispersion in a vacuum oven at 120° C. was characterized by a PTFE content, measured by TGA, heating speed 10° C./min, of 49.9%.

### EXAMPLE 6

A 2 wt % solution of RADEL® R-5800 PPSU in 1-methyl-2-pyrrolidinone (NMP) and acetone was prepared by dissolving under stirring 5 g of PPSU in 159.25 g of NMP and 85.75 g acetone at 25° C. (65/35 NMP/acetone weight ratio).

A one-liter, 4-neck round bottom reaction flask was equipped through its center neck with an overhead stirrer attached to a stainless steel paddle agitator. A thermocouple connected to a temperature controller was attached to one of the side necks, and a nitrogen gas inlet tube with stopper was placed in the other side neck of the round bottom flask. To the front neck of the flask, a 250 ml dropping funnel was installed for addition of the PPSU/NMP/acetone solution.

A 1 wt % solution of nano-PTFE was prepared by mixing 23.81 g of ALGOFLON® NE5 OP341 PTFE aqueous dispersion (21% PTFE; 50 nm average primary particle size) with 476.19 g of de-ionized water at 25° C. This dispersion was then charged to the round bottom flask and agitated at 100 rpm.

From the 250 ml dropping funnel, the 2 wt % PPSU/NMP/acetone solution was then charged drop-wise to the nano-PTFE dispersion over a period of 170 minutes. The resulting core-shell nano-sphere latex was then destabilized by the addition of 75 g of glacial acetic acid to the round bottom flask.

The nano-particles were separated from the mother liquor by pressure filtration through an Advantec Model KST 47 pressure filter (50 psig) equipped with a Millipore PTFE membrane filter medium (47 mm diameter; 1 μm average pore size).

The recovered nano-particles were then charged to an Erlenmeyer flask equipped with a water-jacketed condenser, together with 1000 g of de-ionized water. The resulting slurry was heated to 10° C. and maintained at this temperature for one hour. The coagulum was separated from the wash liquor and dried overnight in a vacuum oven (27 in. Hg) at 120° C.

The core-shell nano-particles contained 50% fluorine by weight. Overall yield of the dried product was 97%.

### EXAMPLE 7

350 ml of a 4 wt % solution of RADEL® A PES in 1-methyl-2-pyrrolidinone (NMP) were prepared by dissolving under stirring PES in NMP in appropriate weight ratio.

A 1.6 wt % solution of nano-PTFE was prepared by mixing 3.15 g of ALGOFLON® NE 10 OP201 PTFE aqueous dispersion (23% PTFE; 68 nm average primary particle size) with 457 g of de-ionized water at 25° C.

The 4 wt % PES/NMP solution was then added drop-wise to the nano-PTFE dispersion at a temperature of 50° C.

The resulting core-shell nano-sphere latex was then destabilized by the addition of an equal volume of a saturated NaCl solution to the round bottom flask.

The core-shell nano-particles were filtered on a Buckner device, washed several times with water for eliminating brine residues and NMP and finally dried in an over for 48 hours at 80° C.

The core-shell nano-particles were found by TGA analysis to contain 5 wt % of PTFE. Overall yield of the dried product was quantitative.

DSC analyses on dried core-shell nano-particles, in particular in cooling scans after annealing at 350° C., evidenced the presence of a crystallization peak centered around 270-C.

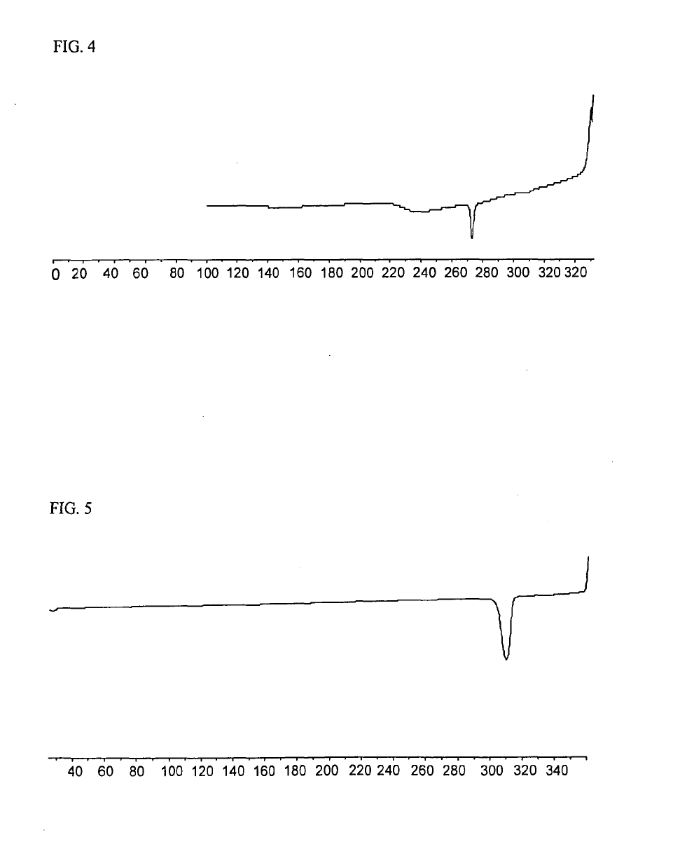

FIG. 4 depicts a DSC cooling scan (cooling rate=10° C./min) recorded using a Mettler Toledo STAR® SW7.01 device of a sample of the core-shell nano-particles of example 7, after 240 minutes of annealing at 350° C. The abscissa represents the temperature in ° C.; ordinate represents the heat flux. FIG. 5 depicts a DSC cooling scan (cooling rate=10° C./min) recorded on a sample of neat PTFE obtained by drying the ALGOFLON® NE 10 OP201 PTFE aqueous dispersion. The abscissa represents the temperature in ° C.; ordinate represents the heat flux.

While “free” PTFE exhibited a unique crystallization peak centered around 310° C., which is characteristic of PTFE chains in extended crystalline domains (crystallization temperature=310° C.), the confined PTFE cores, isolated each others by PES shells, comprised in the core-shell nano-particles of example 7 crystallized in separated domains having lower crystallization temperature (crystallization temperature=270° C.).

1. A core-shell particle comprising:
a core consisting essentially of at least one tetrafluoroethylene (TFE) polymer, said core having an average primary particle size of less than 100 nm; and
a shell consisting essentially of at least one high performance polymer, wherein the polymer (HPP) is chosen among polycondensation polymers that have a heat deflection temperature (HDT) of above 80° C. tinder a load of 1.82 MPa when measured according to ASTM D648.

2. The core-shell particle according to claim 1, wherein the polymer (HPP) is an aromatic polyimide (PI), said polymer (PI) comprising recurring units, more than 50 wt 0% of said recurring units comprising at least one aromatic ring and at least one imide group, as such (formula 1A) or in its amic acid form (formula 1B):

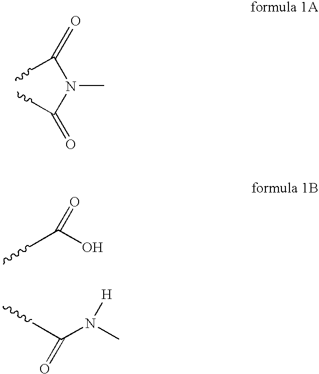

3. The core-shell particle according to claim 2, wherein the polymer (HPP) is an aromatic polyamide-imide (PAI), said polymer (PAI) comprising more than 50 wt % of recurring units comprising at least one aromatic ring, at least one imide group, as such and/or in its amic acid form, and at least one amide group which is not included in the amic acid form of an imide group.

4. The core-shell particle according to claim 3, wherein the recurring units (R3) are chosen among 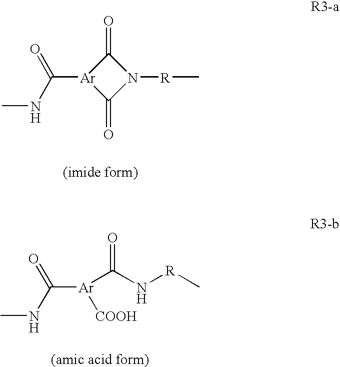
where:
Ar is: 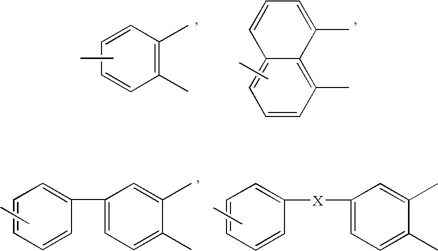
with X= 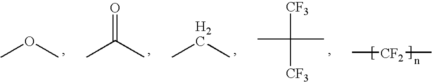
with n=0, 1, 2, 3, 4 or 5;
R is: 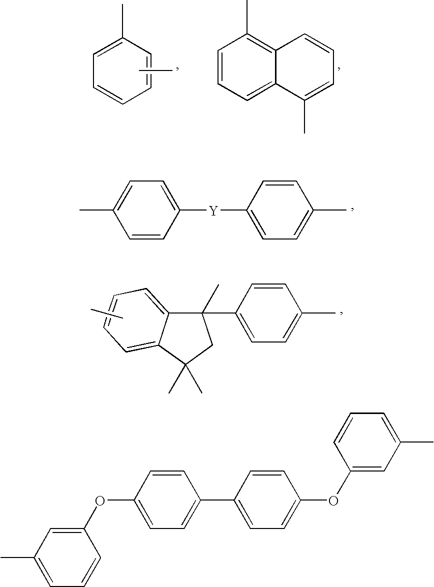
with Y= 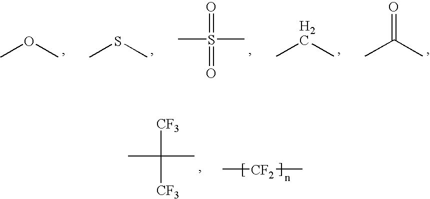
with n=0, 1, 2, 3, 4 or 5

5. The core-shell particle according to claim 1, wherein the polymer (HPP) is an aromatic sulfone polymer, said polymer (P) comprising recurring units (R), at least 50% wt of said recurring units comprising at least one group of formula 1: 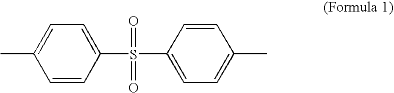
A core-shell particle comprising:

6. The core-shell particle according to claim 5, wherein at least 50% wt of the recurring units (R) of aromatic sulfone polymer (P) are recurring units (R4), in their imide form (R4-A) and/or amic acid forms: 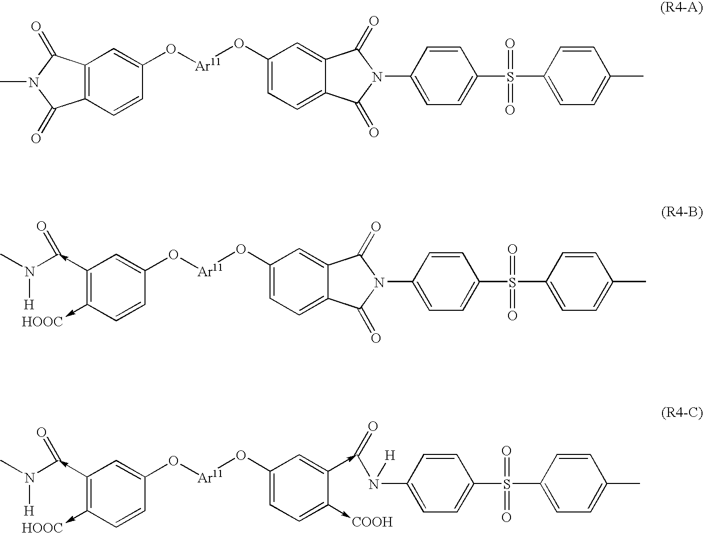
wherein:
the → denotes isomerism so that in any recurring unit the groups to which the arrows point may exist as shown or in an interchanged position;
Ar″ is chosen among the following structures 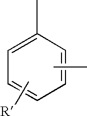
with the linking groups being in ortho, meta or para position and R′ being a hydrogen atom or an alkyl radical comprising from 1 to 6 carbon atoms, 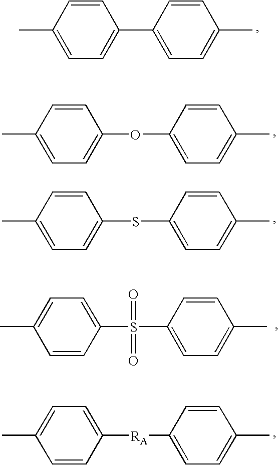
with R_{A} being an aliphatic divalent group of up to 6 carbon atoms, such as methylene, ethylene, isopropylene and the like,
and mixtures thereof.

7. The core-shell particle according to claim 5, wherein at least 50% wt of the recurring units (R) of aromatic sulfone polymer (P) are recurring units (R5) and/or recurring units (R6): 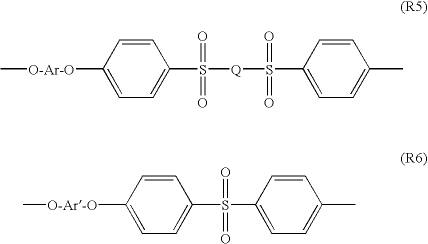
wherein
Q is a group chosen among the following structures 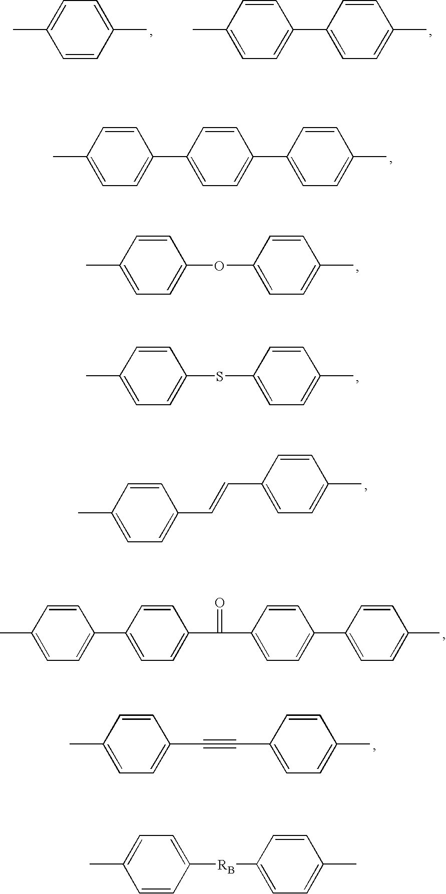
with R_{B} being: 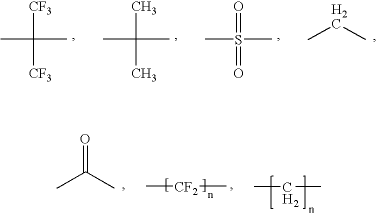
with n=integer from 1 to 6, or an aliphatic divalent group, linear or branched, of up to 6 carbon atoms;
and mixtures thereof;
Ar is a group chosen among the following structures: 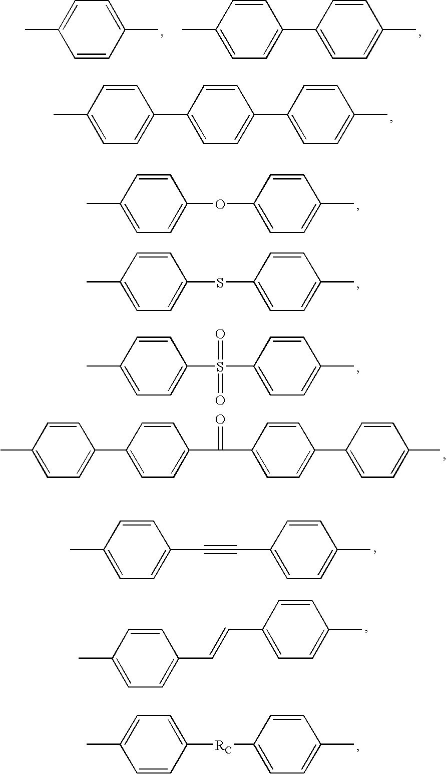
with R_{C} being: 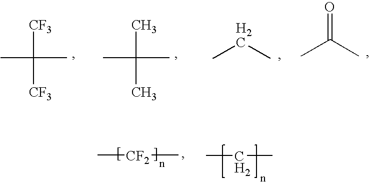
with n=integer from 1 to 6, or an aliphatic divalent group, linear or branched, of up to 6 carbon atoms;
and mixtures thereof;
Ar′ is a group chosen among the following structures 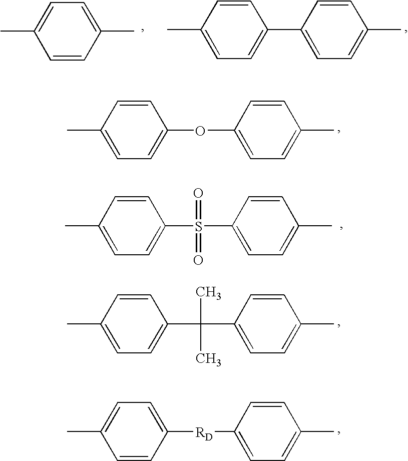
with R_{D} being: 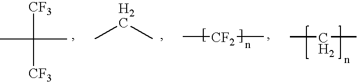
with n=integer from 1 to 6, or an aliphatic divalent group, linear or branched, of up to 6 carbon atoms;
and mixtures thereof.

8. The core-shell particle according to claim 1, wherein the polymer (F) is chosen among homopolymers of tetrafluoroethylene (TFE) or copolymers of TFE with at least one ethylenically unsaturated comonomer, said comonomer being present in the TFE copolymer in an amount from 0.01 to 3% by moles, preferably from 0.01 to 1% by moles, with respect to the total moles of TFE and comonomer (CM).

9. The core-shell particle according to claim 8, wherein the comonomer (CM) is chosen among hexafluoropropylene, perfluoromethylvinylether, perfluoroethylvinylether, perfluoropropylvinylether, perfluorodioxole of formula: 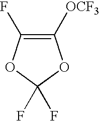
and mixtures thereof.

10. The core-shell particle according to claim 1, said particles comprising from 5 to 95 wt % of polymer (F) based on the total weight of the core-shell particles.

11. The core-shell particle according to claim 1, said particles having a core of average primary particle size of more than 20 nm and less than 70 nm.

12. A process for manufacturing a core-shell particle comprising:
a core consisting essentially of at least one TFE polymer, said core having an average primary particle size of less than 100 nm
a shell consisting essentially of at least one high performance polymer,
said process comprising
(i) preparing a dispersion of polymer (F) nanoparticles in water;
(ii) dissolving polymer (HPP) in a solvent (SV), to give a polymer (HPP) solution;
(iii) adding said solution (S) to said dispersion (D).

13. The process according to claim 12, wherein the dispersion (D) is obtained from a process comprising a microemulsion polymerization step, comprising:
(a) preparing an aqueous microemulsion of perfluoropolyether (PFPE) in water with a fluorinated surfactant;
(b) polymerizing a monomer mixture comprising TFE in a aqueous medium comprising said microemulsion and a water-soluble radical initiator.

14. The process of claim 12, wherein the solvent (SV) is chosen among N-methylpyrrolidone (NMP), N,N-dimethylformamide (DMF), N,N-dimethylacetamide (DMAC), sulfolane and their mixtures.

15. Use of the core-shell particle according to claim 1 or obtained via the process according to claim 12 for improving dispersion of polymer (F) nanoparticles in a polymer composition.

16. A polymer composition comprising the core-shell particle according to claim 1 or obtained via the process according to claim 12.

17. An article comprising the core-shell particle according to claim 1 or obtained via the process according to claim 12 or the composition according to claim 16.
